(19) United States
(12) Patent Application Publication
(10) Pub. No.: US 2025/0111381 A1
(43) Pub. Date: Apr. 3, 2025

(54) FOOTWEAR AUTHENTICATION USING PRESSURE DISTRIBUTION IMAGE ANALYSIS

(71) Applicant: eBay Inc., San Jose, CA (US)

(72) Inventor: Dmitry Paskalov, Cliffside Park, NJ (US)

(21) Appl. No.: 18/374,324

(22) Filed: Sep. 28, 2023

(51) Int. Cl. G06Q 30/018; G01L 5/00; G01N 19/00

(52) U.S. Cl. CPC G06Q 30/018; G01L 5/0038; G01N 19/00

(57) ABSTRACT

Systems and methods are directed to authenticating footwear based on pressure distribution image analysis. An authentication system receives a request to authenticate footwear and accesses a pressure distribution image for the footwear, whereby the pressure distribution image comprises a pressure distribution represented by colors that is generated based on a predetermined force applied to the footwear. The authentication system then analyzes the pressure distribution image including comparing the pressure distribution image to a pressure distribution image of an authentic version of the footwear. Based on the analyzing, the authentication system determines whether the pressure distribution image is within an authenticity threshold of the pressure distribution image of the authentic version. Based on the pressure distribution image being within the authenticity threshold, an indication of authenticity of the footwear is presented.

### TECHNICAL FIELD

The subject matter disclosed herein generally relates to authenticating footwear. Specifically, the present disclosure addresses systems and methods that authenticates footwear using pressure distribution image analysis.

### BACKGROUND

Sellers typically are hesitant to sell high-end or luxury items if they are not certain that they will receive the same item back in case of a return and not a fake version of the item. Similarly, buyers are hesitant to purchase high-end or luxury items if they are not certain the items are authentic. This level of trust is extremely important for categories such as designer shoes or brand name sneakers and athletic shoes (collectively referred to as “footwear”). These types of goods are frequently forged to a level that only an expert may be able to authenticate them.

### BRIEF DESCRIPTION OF THE DRAWINGS

FIG. 1 is a diagram illustrating an example network environment suitable for authenticating footwear based on pressure distribution image analysis, according to example embodiments.

FIG. 2 is a diagram illustrating components of an authentication system that authenticates footwear based on pressure distribution image analysis, according to example embodiments.

FIG. 3A is an example image of a pressure distribution heat map for both a right and left shoe.

FIG. 3B is an example image of a pedobarographic measurement image for both a right and left shoe.

FIG. 4 is a flowchart illustrating operations of a method for authenticating footwear using pressure distribution image analysis, according to example embodiments.

FIG. 5 is a flowchart illustrating operations of a method for performing statistical pressure distribution image analysis, according to example embodiments.

FIG. 6 is a flowchart illustrating operations of a method for performing machine-learning pressure distribution image analysis, according to example embodiments.

FIG. 7 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Example embodiments address the technical problem of authenticating footwear in a computationally efficient manner based on pressure distribution image analysis. When producing a fake version of a designer or brand name footwear, a counterfeiter tries to make the fake footwear have the appearance of the authentic footwear. However, materials that are used typically are not the same, especially if the material is on the inside of the footwear, such as in the sole.

Additionally, many designer and brand name footwear have patented technology associated with their soles. In particular, the technologies are directed to distributing a weight of an individual wearing the footwear in a way that attempts to maximize comfort. Thus, example embodiments test the pressure distribution on a shoe (e.g., a sole of the shoe) in order to identify whether the shoe is authentic or fake. For purposes of discussion, the terms “footwear” and “shoe” are used interchangeably.

To test a shoe, a pressure distribution image for the shoe is analyzed. In some cases, the pressure distribution image is generated using a pressure measurement machine with an artificial foot (or similar apparatus) having a plurality of sensors thereon. The artificial foot applies a predetermined force to the shoe. The predetermined force is a same force applied to the authentic version of the shoe. The sensors may detect the pressure exerted by the sole in response and may record the pressure measurement in the form of an image. The image can be a pressure distribution heat map or a pedobarographic measurement image. In further embodiments, the pressure may be recorded in a form of a table, a matrix, or other forms of pressure distribution data without a graphical representation.

An image analysis authentication system then analyzes the pressure distribution image by comparing the pressure distribution image to a pressure distribution image of an authentic version of the shoe. In further embodiments, the authentication system may analyze the pressure distribution table or matrix instead of an image in a similar way. In example embodiments, the analysis can be performed using either a statistical model or a machine learning model. In some case, the statistical model is a statistical color model that is configured to detect particular colors (and their locations) in the pressure distribution image. The particular color/location dataset can then be compared to a dataset for an authentic version of the shoe being tested and a determination made whether the comparison is within an authenticity threshold.

For the machine learning model, the pressure distribution image can be applied to a machine learning model that has been trained with training data derived from pressure distribution images of authentic and counterfeit footwear. A probability that the test footwear is authentic is outputted from the machine learning model and compared to a probability (authenticity) threshold. If the authenticity (probability) threshold is satisfied, then the test footwear is labeled as authentic. In some cases, the machine learning model comprises one or more neural networks (e.g., convolution neural networks (CNNs)) trained to determine similarities (e.g., similarity scores) between the pressure distribution image of the test shoe and a pressure distribution image of an authentic version of the shoe. The similarity scores are compared to an authenticity threshold.

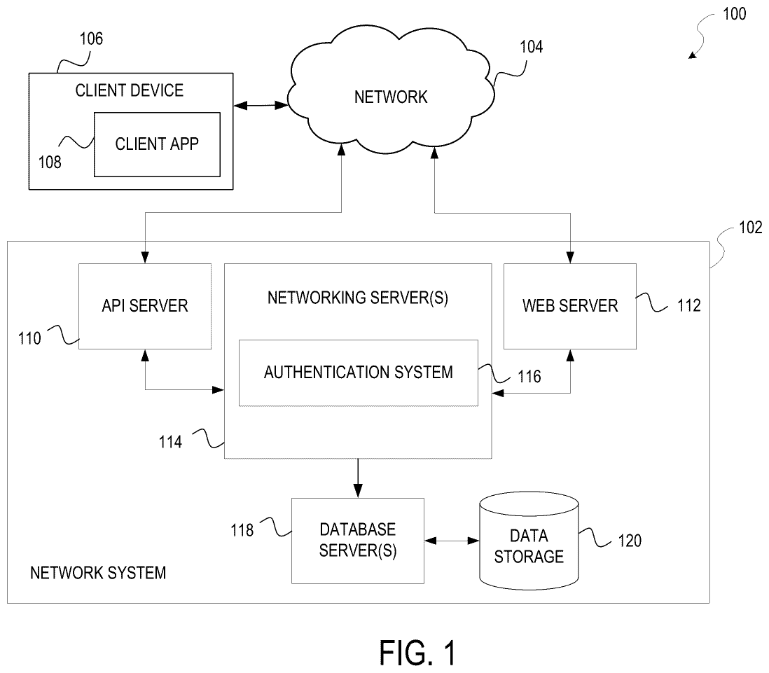

FIG. 1 is a diagram illustrating an example network environment 100 suitable for authenticating footwear based on pressure distribution image analysis, according to example embodiments. A network system 102 provides server-side functionality via a communication network 104 (e.g., the Internet, wireless network, cellular network, or a Wide Area Network (WAN)) to a client device 106. The network system 102 is configured to authenticate footwear using either a statistical model or a machine learning model to analyze pressure distribution images, as will be discussed in more detail below.

In various cases, the client device 106 is a device associated with a user account of a user of the network system 102 that wants to make sure that the footwear they are/will be in possession of is authentic. For example, the user may be a seller that wants to verify that returned shoes are the same authentic shoes that were sold. In other cases, the client device 106 is a device associated with a user account of a buyer of the network system 102 that wants to ensure that shoes that they purchased are authentic. Further still, the client device 106 may be a device of an operator associated with an intermediary that authenticates footwear on behalf of the seller or buyer. In some cases, the intermediary may be a part of a same entity that controls the network system 102.

The client device 106 comprises one or more client applications 108 that communicate with the network system 102 for added functionality. For example, the client application 108 may be a local version of an application or component of the network system 102. Alternatively, the client application 108 exchanges data with one or more corresponding components/applications at the network system 102. The client application 108 may be provided by the network system 102 and/or downloaded to the client device 106. A request for authentication of footwear can be sent via the client application 108. In return, the client application 108 receives an indication of whether the shoe is authentic after evaluation.

In one embodiment, the client application 108 comprises an authentication component that exchanges data with the network system 102. In some cases, the client application 108 works with or triggers a pressure measurement machine having an artificial foot (or similar apparatus) having a plurality of sensors that applies a predetermined force to a shoe to be authenticated (also referred to herein as the “test shoe” or “test footwear”) to generate pressure distribution data or image and transmits the pressure distribution data or image to the network system 102 for analysis. In one embodiment, the pressure measurement machine may be a part of the client device 106. In other embodiments, the pressure measurement device is a stand-alone device that can be communicatively coupled (e.g., via the network 104) to the client device 106 and the network system 102. In these cases, the pressure measurement device may be associated with (e.g., owned by) a same entity that controls the network system 102.

The client device 106 interfaces with the network system 102 via a connection with the network 104. Depending on the form of the client device 106, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

The client device 106 may comprise, but is not limited to, a smartphone, tablet, laptop, multi-processor systems, microprocessor-based or programmable consumer electronics, game consoles, set-top boxes, a server, or any other communication device that can access the network system 102. The client device 106 may comprise a display component (not shown) to display information (e.g., in the form of user interfaces) including an indication of whether footwear is authentic. The client device 106 can be operated by a human user and/or a machine user.

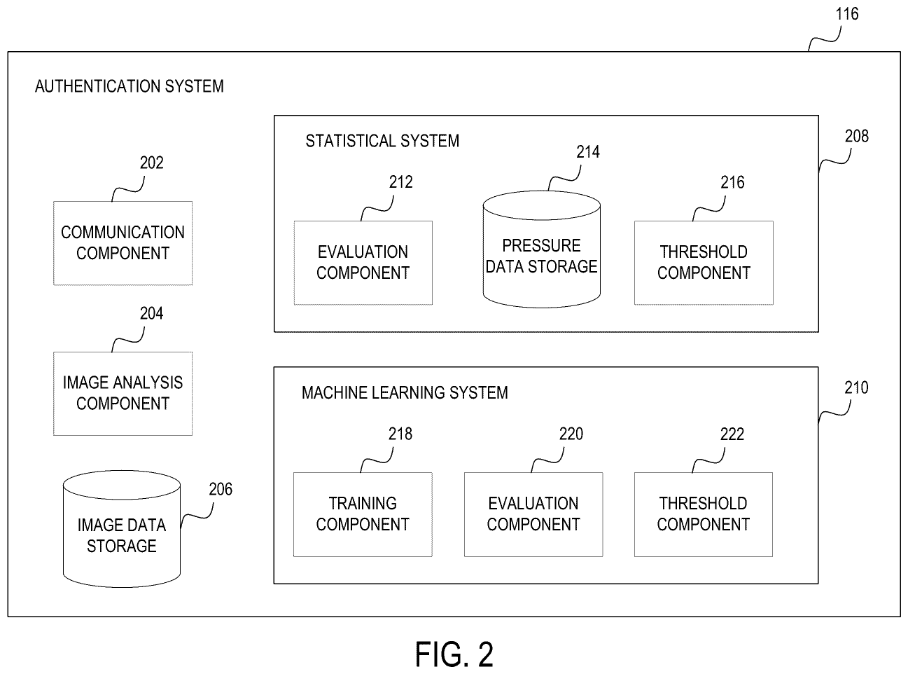

Turning specifically to the network system 102, an application programing interface (API) server 110 and a web server 112 are coupled to, and provide programmatic and web interfaces respectively to, one or more networking servers 114. The networking server(s) 114 host various systems including an authentication system 116, which comprises a plurality of components and which can be embodied as hardware, software, firmware, or any combination thereof. The authentication system 116 will be discussed in more detail in connection with FIG. 2.

The networking server(s) 114 are, in turn, coupled to one or more database servers 118 that facilitate access to one or more storage repositories or data storage 120. The data storage 120 is a storage device storing, for example, user accounts including user profiles (e.g., of a buyer, seller, or intermediary) and items associated with their user account (e.g., footwear that they own, sold, or bought).

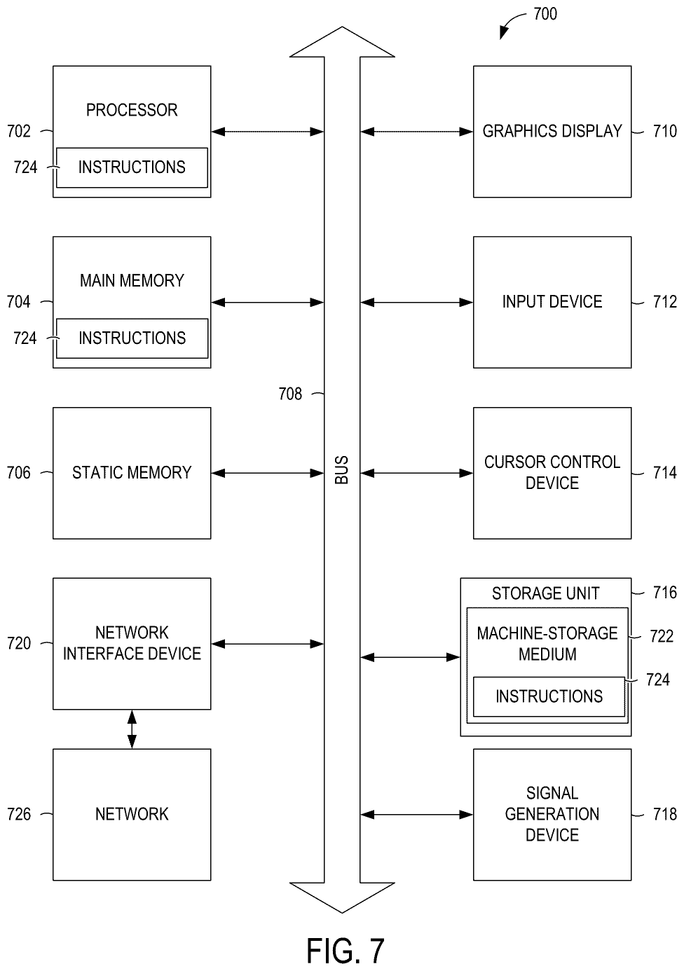

Any of the systems, servers, data storage, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one system may, in alternative examples, be embodied in a different system. For example, any number of client devices 106 or data storage 120 may be embodied within the network environment 100. While only a single network system 102 is shown, alternatively, more than one network system 102 can be included (e.g., localized to a particular region).

FIG. 2 is a diagram illustrating components of the authentication system 116 that authenticates footwear based on pressure distribution image analysis, according to example embodiments. The authentication system 116 accesses a pressure distribution image of a test shoe, analyzes the pressure distribution image, and determines whether the pressure distribution image is within an authenticity threshold of a pressure distribution image of an authentic version of the shoe. To enable these operations, the authentication system 116 comprises a communication component 202, an image analysis component 204, an image data storage 206, and image analysis systems all configured in communication with one another (e.g., via a bus, shared memory, or a switch). The image analysis systems include a statistical system 208 and a machine learning system 210. In some embodiments, the authentication system 116 may comprise the statistical system 208 and not the machine learning system 210 or comprise the machine learning system 210 and not the statistical system 208.

The communication component 202 is configured to exchange data with other components of the network environment 100. Thus, the communication component 202 receives, from the client application 108 operating on the client device 106, a request to authenticate footwear. In some cases, the request includes a pressure distribution image of the footwear to be authenticated. In other cases, the request indicates the pressure distribution image to retrieve (e.g., previously uploaded to the image data storage 206) for analysis. The request can also include details of the footwear including a year of manufacture or purchase, brand, model name, and/or serial number. After analysis by the authentication system 116, the communication component 202 can transmit a response to the query that includes an indication of the authenticity of the footwear.

In embodiments where the pressure distribution image of the test footwear was previously uploaded or uploaded by another entity (e.g., an intermediary that tests items), the image analysis component 204 retrieves the pressure distribution image of the test footwear from the image data storage 206. In example cases, the image data store 206 may also comprise a database of pressure distribution images for different brands and models of authentic footwear. These pressure distribution images for different brands and models of authentic footwear can be used for comparison and for training of the machine learning model, as will be discussed in more detail below. Periodically, new pressure distribution images are received (e.g., with a new product release) and the machine learning model retrained.

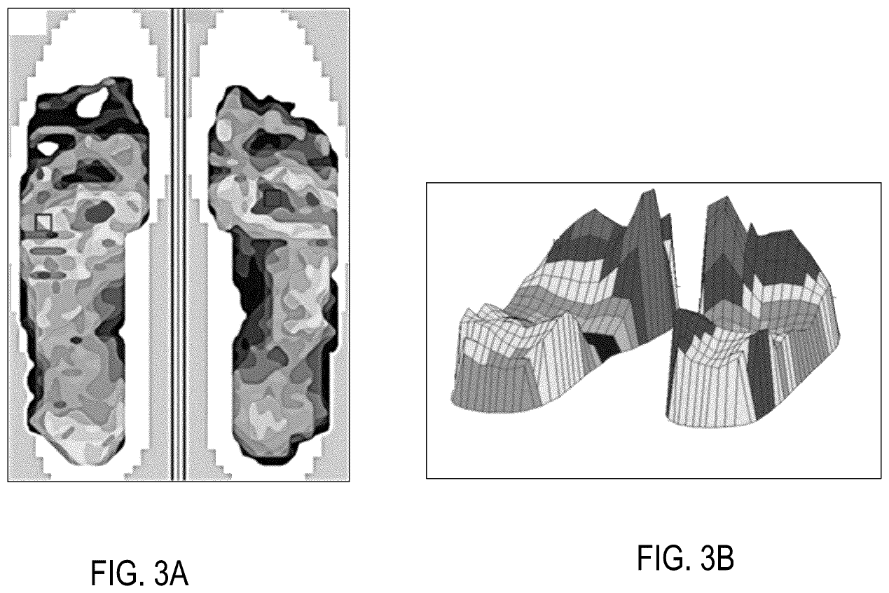

In some cases, a pressure distribution image may comprise a heat map of foot pressures measured by a pressure measurement machine at different locations on the sole. FIG. 3A illustrates an example of a pressure distribution heat map for both a right and left shoe. In some cases, the pressure distribution image comprises a pedobarographic measurement image as shown in FIG. 3B. The different colors correspond to different pressure measurements. For example, red can indicate greater than 195 kilopascal (kPA), a mid-range green can indicate 100 kPA, and a dark blue can indicate 10 kPA.

The pressure measurements in both types of pressure distribution images are obtained from a pressure measurement machine. The pressure measurement machine comprises an artificial foot or similar apparatus with a plurality of pressure sensors positioned at different locations. When the artificial foot applies a predetermined amount of force to a shoe, the pressure sensors capture an amount of pressure at each of the locations. The amount of pressure at each location can then used to generate the pressure distribution image.

In further embodiments, the pressure distribution images may comprise a video of dynamic pressure distributions during a step performed using the pressure measurement machine. With a step, the sole absorbs energy and then transfers the energy via the sole to a plurality of sensors. As such, the plurality of sensors of the pressure measurement machine continuously captures pressure measurements during the step. The continuous pressure measurements (e.g., the dynamic pressure measurements) are compiled into the video or a data stream, whereby for each time t, a different heat map or pressure distribution table or matrix may be generated.

In some cases, the image analysis component 204 may preprocess the pressure distribution image of the test shoe prior to passing the data to either the statistical system 208 or the machine learning system 210. For example, the test shoe may be in a size that the authentication system 116 does not have authenticate pressure distribution data for. In these cases, the image analysis component 204 can “resize” the image to a size for which the authentication system 116 does have authenticate pressure distribution data. In another embodiments, the image analysis component 204 may utilize available algorithms for enlarging or shrinking of the existing authenticated pressure image data such as nearest neighbor or bilinear interpolation algorithms.

In embodiments that use statistical analysis, the pressure distribution image for the test shoe is provided to the statistical system 208. The statistical system 208 uses statistical analysis (e.g., a statistical image model) to determine whether the test shoe is authentic. Accordingly, the statistical system 206 comprises an evaluation component 212, a pressure data storage 214, and a threshold component 216.

The evaluation component 212 is configured to apply the pressure distribution image to a statistical model. In one embodiment, the statistical model is a statistical color model trained to detect particular colors (and shades of colors) and their locations in the pressure distribution image. The detected color/location dataset can then be compared to a corresponding dataset for an authentic version of the shoe. The corresponding dataset may be retrieved from the pressure data storage 214. The evaluation component 212 then compares the datasets. In performing the comparison, the evaluation component 212 may determine the percentage of pressure measurements (color/location data) that is within a threshold (e.g., within 95%) of the corresponding pressure measurement from the pressure data storage 214. This percentage can be an authentication score. In another embodiment, the pedobarographic Statistical Parametric Mapping (pSPM) method may be utilized to compare the datasets.

In some embodiments, the comparison takes into consideration the age of the test shoe. Because materials of the sole change and deform at different rates with usage, the age of the test shoe can be important. In these embodiments, the pressure data storage 214 will include different datasets for pressure distribution (or location/pressure/time vectors) for a same brand/model for different years.

For a pressure distribution video, an added parameter of time is considered. Thus, the dataset is comprised of color and location at specific times. In performing the comparison, the evaluation component 212 can determine the percentage of pressure measurements (color/location data) at each timeframe that is within a threshold (e.g., within 95%) of the corresponding pressure measurement from the pressure data storage 214. An average or median of these percentages can then be determined to derive the authentication score.

The threshold component 216 determines whether the test shoe is authentic based on the authentication score determined from the evaluation performed by the evaluation component 212. In example embodiments, the authentication score comprises the percentage of the locations where the pressure (e.g., color) is within a threshold of the corresponding value or color of the authentic version. For example, if the pressure measurements at 90% or more (e.g., an authenticity threshold of 90% or 0.9) of the locations is within the threshold of the corresponding pressure in the database, the threshold component 216 labels the test shoe authentic. In some cases, the authenticity threshold is the same for all types of shoes for a particular brand or category. In other cases, the authenticity threshold is different based on the brand, model, and/or category. In some cases, the threshold component 216 can be a part of the evaluation component 212.

In embodiments that use machine learning analysis, the pressure distribution image is provided to the machine learning system 210. The machine learning system 210 is configured to train one or more machine learning (ML) authentication models to determine probabilities that pressure distribution images of test footwear are authentic. The machine learning system 210 also refines the ML authentication model by retraining with updated training data. During inference or runtime, the machine leaning system 210 uses the trained ML authentication model to determine a probability that the test shoe is authentic.

To enable these operations, the machine learning system 210 includes a training component 218, an evaluation component 220, and a threshold component 222 all configured to communicate with each other (e.g., via a bus, shared memory, or a switch). While FIG. 2 shows the training component 218 and the evaluation component 220 being embodied within the machine learning system 210, alternatively, the training component 218 can be separate from the evaluation component 220 in a different system or server.

In some embodiments, the training component 218 trains the authentication models using pressure distribution images for both authentic and counterfeit shoes as training data. In some cases, location/color data pairs (or location/color/time vectors for videos) for both authentic and counterfeit shoes are extracted from the corresponding pressure distribution images and used as training data to train the authentication models. The machine learning can occur using an artificial intelligence such as a neural network. For example, the neural network can be trained by providing a set of pressure distribution images (or location/pressure data pairs) for authentic footwear and a set of pressure distribution images of corresponding counterfeit footwear. Weights can then be adjusted accordingly to receive a desired result. The training of the authentication model may include training for probabilities (e.g., authentication scores) that footwear is authentic. For consistency, the predetermined amount of force (as well as the size and shape of the artificial foot) applied by the pressure measurement machine to each shoe should be the same for the authentic footwear, counterfeit footwear, and the footwear to be authenticated.

In some cases, additional data can be included in the training data to improve accuracy. The additional data can include year of production of the authentic shoe and where the authentic shoe was made. This may be determined from a label (e.g., an image of the label) found on the inside of the shoe. For example, quality and characteristics of materials used in the sole can change through the years with materials or manufacturing being slightly different between different factories/locations. Additionally, materials deteriorate based on usage/age. As such, the training data can include pressure distribution data for different ages (e.g., year of manufacture) of a same type/model of authentic footwear.

Any number of authentication models can be trained. For instance, a separate model can be trained for each brand and model of authentic footwear (e.g., Gucci New Ace GG Supreme Trainer). Alternatively, the authentication model may be trained for a particular brand (e.g., Louis Vuitton, Gucci, Prada, Nike) and/or category of footwear (e.g., high top, high heels).

Over time, the training data may be updated to refine the authentication models. For example, with each passing year, the pressure measurements may become greater in some locations of a sole or change for different authentic footwear. Additionally, new versions of authentic footwear are constantly being created (e.g., same model but with different material, same model and material but manufactured in a different location, same model with different sole technology). The training data may be updated to reflect these changes and the corresponding ML authentication models retrained.

During runtime or inference time, the evaluation component 220 of the machine learning system 210 is configured to determine a probability that a test footwear is authentic. Thus, the pressure distribution image is applied to the appropriate ML authentication model by the evaluation component 220. In some cases, the evaluation component 220 formats the pressure distribution image into one or more input vectors of color and location data pairs (e.g., extracts color/location data pairs as features). That is, at different locations of the pressure distribution image, a corresponding color can be identified. The input vector is then applied to the corresponding ML authentication model by the evaluation component 220. The ML authentication model then provides a result that is a probability (or percentage) that the test footwear is authentic.

The probability (e.g., authentication score) outputted by the evaluation component 220 is then compared to an authenticity threshold by the threshold component 222. In some cases, the authenticity threshold is the same for all types of footwear for a particular brand or category. In other cases, the authenticity threshold is different based on the brand, model, and/or category. For example, the authenticity threshold may be a probability of 0.8 or 80% for designer sneakers. Thus, a probability of 0.79 outputted by the evaluation component 220 results in the test footwear being labeled fake or not authentic, while a probability of 0.82 results in the test footwear being labeled authentic.

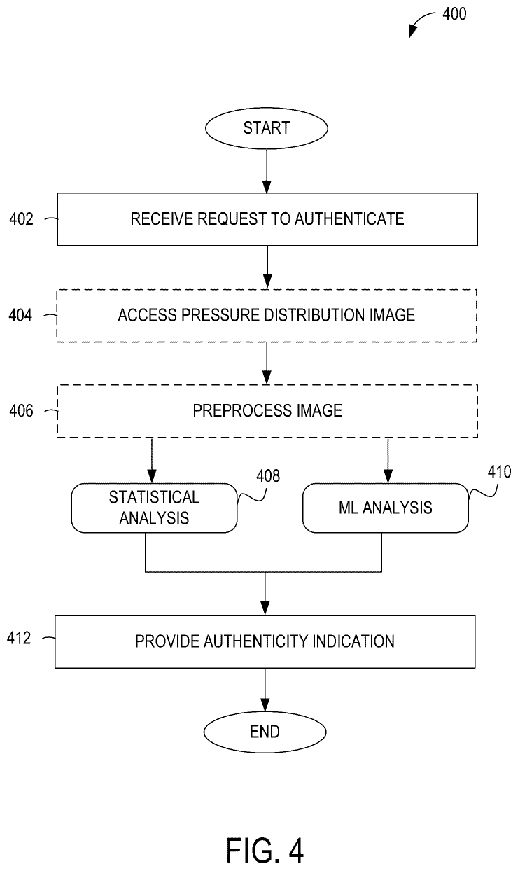

FIG. 4 is a flowchart illustrating operations of an example method 400 for authenticating footwear, according to example embodiments. Operations in the method 400 may be performed by the authentication system 116, using components described above with respect to FIG. 2. Accordingly, the method 400 is described by way of example with reference to the authentication system 116. However, it shall be appreciated that at least some of the operations of the method 400 may be deployed on various other hardware configurations or be performed by similar components residing elsewhere in the network environment 100. Therefore, the method 400 is not intended to be limited to the authentication system 116.

In operation 402, the authentication system 116 (e.g., the communication component 202) receives a request to authenticate footwear. The request can be received from a seller, a buyer, or an intermediary that authenticates footwear on behalf of the seller or buyer. In some cases, the request includes a pressure distribution image for the footwear to be authenticated (e.g., a request from an intermediary that has a pressure measurement machine). Additionally or alternatively, the request can include one or more of a serial number associated with the footwear, a year purchased or manufactured, or a brand/model of the footwear. In some cases, the request does not include the pressure distribution image but a reference to the pressure distribution image that is uploaded to the image data storage 206.

In operation 404, the image analysis component 204 accesses the previously uploaded pressure distribution image of the footwear. In some cases, the pressure distribution image may have been received from a different entity than a user that sends the request. For example, the footwear in question may be a return from a buyer to a seller which gets shipped to an intermediary that performs the authentication. In this case, the intermediary may have the pressure measurement machine that generates the pressure distribution image and uploads it to the image data storage 206. Here the request to authenticate may be sent by the seller or an individual associated with the intermediary. A similar scenario may be that the intermediary receives the footwear from a seller prior to forwarding the footwear to a buyer and performs authentication on behalf of the buyer (e.g., request is from buyer or intermediary). Further still, a seller may want to pre-authentic footwear prior to offering the footwear for sale (e.g., request is from the seller or intermediary). In embodiments where the request includes the pressure distribution image, operation 404 is skipped (e.g., operation 404 is optional or not needed).

In operation 406, the image analysis component 204 preprocesses the pressure distribution image of the test footwear. For example, the test footwear may be in a size that the authentication system 116 does not have authenticate pressure distribution data for. In these cases, the image analysis component 204 “resizes” the image to a size for which the authentication system 116 does have authenticate pressure distribution data. In embodiments where resizing is not needed, operation 406 is optional or not needed.

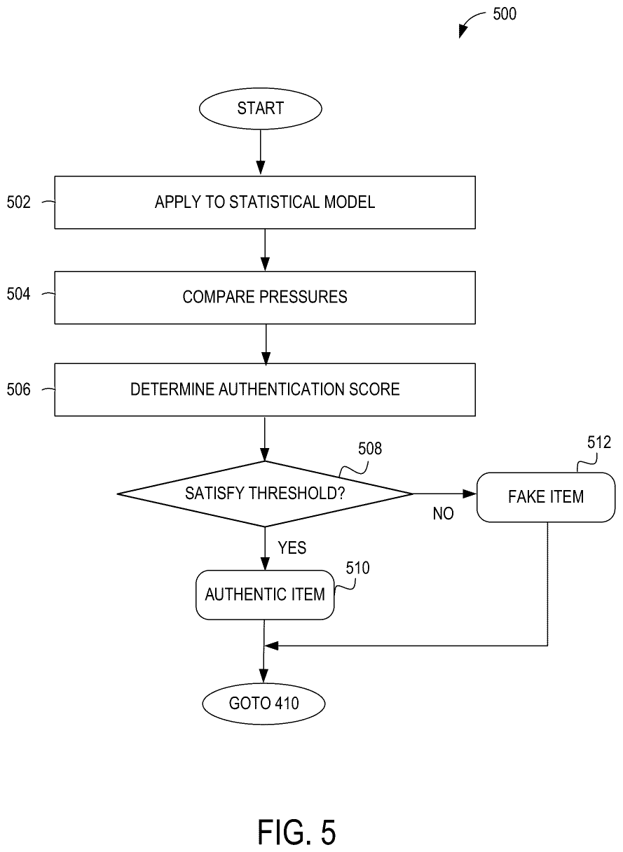

In embodiments that use statistical analysis, the method 400 proceeds to operation 408 where statistical image analysis is performed. Operation 408 will be discussed in more detail in connection with FIG. 5 below.

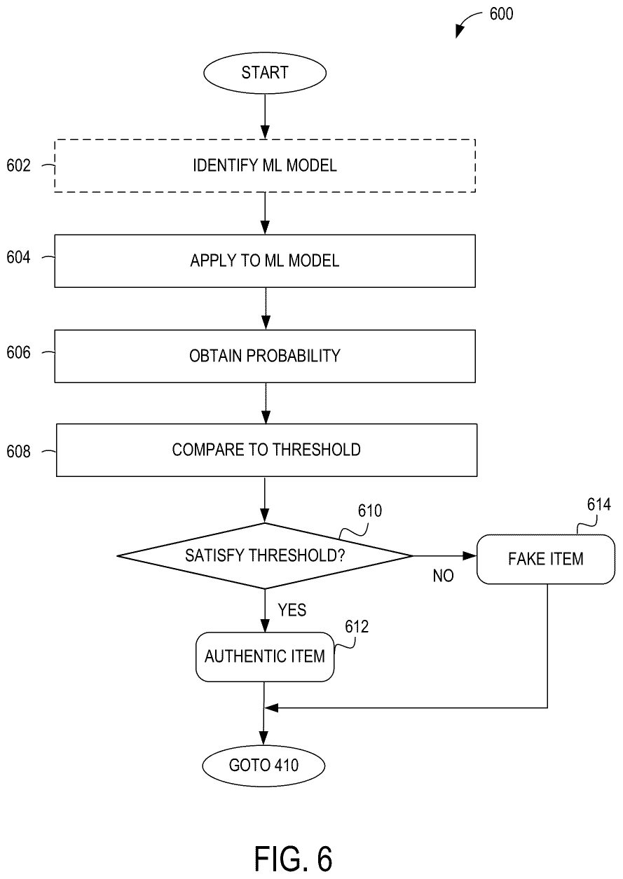

In embodiments that use machine learning analysis, the method 400 proceeds to operation 410 where machine learning analysis is performed. Operation 410 will be discussed in more detail in connection with FIG. 6 below.

In operation 412, an indication of the authenticity of the footwear is provided. In some cases, the indication can be displayed on a user interface of the client device 106 via the client application 108. In other cases, an electronic communication (e.g., email, text message) can be generated and sent to the client device 106. In cases where an item being authenticated is (or will be) listed for sale with the network system 102, a badge indicating the authenticity of the footwear can be graphically included in a display of the listing for the footwear.

FIG. 5 is a flowchart illustrating operations of a method 500 (e.g., operations 408) for pressure distribution image analysis, according to example embodiments. Operations in the method 500 may be performed by the authentication system 116, using components described above with respect to FIG. 2. Accordingly, the method 500 is described by way of example with reference to the authentication system 116. However, it shall be appreciated that at least some of the operations of the method 500 may be deployed on various other hardware configurations or be performed by similar components residing elsewhere in the network environment 100. Therefore, the method 500 is not intended to be limited to the authentication system 116.

In operation 502, the evaluation component 212 applies the pressure distribution image to a statistical model. In one embodiment, the statistical model comprises a statistical image model that is trained to identify various colors (e.g., shades of colors) at different locations on the pressure distribution image. In some cases, a color/location dataset can be generated by the statistical image model.

In operation 504, the evaluation component 212 compares the color/location dataset from the pressure distribution image of the footwear to be authenticated to a corresponding color/location dataset accessed from the pressure data storage 214. The evaluation component 212 uses the identification/information associated with the footwear (e.g., received with the request) to access the corresponding color/location dataset for the authentic version of the footwear. In some cases, the pressure data storage 214 includes different pressure distributions for a same brand/model for different years. As such, the information associated with the footwear can include a year of purchase or manufacture and/or location of manufacture of the footwear.

The evaluation component 212 compares the color (representing a pressure measurement) at the various locations along the sole with the corresponding color/location dataset for the sole of the authentic version of the footwear. In performing the comparison, the evaluation component 212 may determine whether each of the color/location measurement is within a comparison threshold (e.g., 95%) of the corresponding color/location measurement for the authentic version of the footwear.

In operation 506, the threshold component 216 determines an authentication score based on the comparison. The authentication score can comprise a percentage of the locations where the pressure measurement of the test footwear are within a comparison threshold of the corresponding pressure measurement for the authentic version. For example, if nine out of ten locations are within a threshold of the corresponding pressure measurement for the authentic version of the footwear, the authentication score is 0.9 or 90%.

In operation 508, a determination is made whether the authentication score satisfies (e.g., meets or transgresses) the authenticity threshold. For example, if the pressure measurement at 90% (e.g., an authentication threshold of 90% or 0.9) of the locations is within the threshold of the corresponding pressure for the authentic version of the footwear, the threshold component 216 labels the test footwear authentic in operation 510. If the authentication score does not satisfy the authenticity threshold, then the footwear is labeled a fake item in operation 512.

In some cases, the authenticity threshold is the same for all types of footwear for a particular brand or category. In other cases, the authenticity threshold is different based on the brand, model, and/or category. The authenticity threshold can be a default threshold, be configurable by an operator of the authentication system 116 or be machine-learned. For example, the training of the machine learning models can include training one or more models to determine the authenticity threshold.

FIG. 6 is a flowchart illustrating operations of a method 600 (e.g., operations 410) for performing machine-learning pressure distribution image analysis, according to example embodiments. Operations in the method 600 may be performed by the authentication system 116, using components described above with respect to FIG. 2. Accordingly, the method 600 is described by way of example with reference to the authentication system 116. However, it shall be appreciated that at least some of the operations of the method 600 may be deployed on various other hardware configurations or be performed by similar components residing elsewhere in the network environment 100. Therefore, the method 600 is not intended to be limited to the authentication system 116.

In operation 602, a ML authentication model that corresponds to the footwear to be authenticated is identified by the evaluation component 220. In some cases, a separate machine learning model is trained for each brand and model of authentic footwear. Alternatively, the machine learning models may be trained for a particular brand (e.g., Louis Vuitton, Gucci, Prada) or category of item (e.g., designer sneakers, designer high heels). In these cases, the corresponding machine learning model is identified. As such, operation 602 may be optional in cases where only a single ML authentication model is trained.

In operation 604, the pressure distribution image of the test footwear is applied to a corresponding machine learning model by the evaluation component 220. In some cases, the entire pressure distribution image is applied to the ML authentication model. In other cases, the evaluation component 220 may extract features from the pressure distribution image. For example, the features can include colors at different locations on the pressure distribution image. The features can then be formatted into one or more input vector(s) that are applied to the ML authentication model by the evaluation component 220. In some cases, additional information can be formatted into one or more of the input vectors. The additional information can include, for example, a year (e.g., manufactured, purchased) and location (e.g., manufactured) associated with the footwear.

In operation 606, an authentication or probability score is obtained from the ML authentication model. The probability score indicates a probability that the test footwear is authentic (e.g., the pressure distribution image of the test footwear matches the corresponding pressure distribution image for the authentic version).

The authentication score is then compared to an authenticity threshold in operation 608 by the threshold component 222. In some cases, the authenticity threshold is the same for all types of footwear for a particular brand or category. In other cases, the authenticity threshold is different based on the brand, model, and/or category. For example, the authenticity threshold may be a probability of 0.8 or 80% for designer sneakers. The authenticity threshold can be a default threshold, be configurable by an operator of the authentication system 116 or be machine-learned.

In operation 610, a determination is made by the threshold component 222 whether the authentication score satisfies (e.g., meets or transgresses) the authenticity threshold. For example, an authentication probability of 0.79 outputted by the evaluation component 220 would not satisfy a 0.8 authenticity threshold. If the authentication score or probability does satisfy the authenticity threshold, the threshold component 222 labels the footwear authentic in operation 612. If the authentication score or probability does not satisfy the authenticity threshold, then the footwear is labeled a fake item in operation 614.

Some counterfeiters may substitute one fake shoe with a real shoe (e.g., real left shoe but fake right shoe). As such, the analysis can be performed for both left and right shoes in a pair before labeling the pair as authentic.

While example embodiments are discussed above using a pressure distribution image, alternative embodiments can use pressure distribution data that does not include a graphic, such as a pressure distribution table or matrix. In these embodiments, a table or matrix of pressure measurements at different locations (and time, in the case of video) can be obtained from a pressure measurement machine. Alternatively, a pressure distribution image can be preprocessed (e.g., by the image analysis component 204) to generate the table or matrix. The table or matrix can then to be transmitted to the statistical system 208 or the machine learning system 210 for analysis. The statistical system 208 can compare the values in the table or matrix with a corresponding table or matrix of values for the authentic version. Alternatively, the machine learning system can apply the values in the table or matrix to a corresponding ML model.

FIG. 7 illustrates components of a machine 700, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flow diagrams of FIG. 4 to FIG. 6. In one embodiment, the instructions 724 can transform the machine 700 into a particular machine (e.g., specially configured machine) programmed to carry out the described and illustrated functions in the manner described.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more components described herein.

The machine 700 may further include a graphics display 710 (e.g., a plasma display panel (PDP), a light emitting diode (LED) display, a liquid crystal display (LCD), a projector, or a cathode ray tube (CRT), or any other display capable of displaying graphics or video). The machine 700 may also include an input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-storage medium 722 (e.g., a tangible machine-storage medium) on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered as machine-storage media (e.g., tangible and non-transitory machine-storage media). The instructions 724 may be transmitted or received over a network 726 via the network interface device 720.

In some example embodiments, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed embodiments.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented components may be located in a single geographic location (e.g., within a home environment, an office environment, or a server farm). In other example embodiments, the one or more processors or processor-implemented components may be distributed across a number of geographic locations.

### EXAMPLES

Example 1 is a method for authenticating footwear using pressure distribution image analysis. The method comprises receiving a request to authenticate footwear; accessing a pressure distribution image for the footwear, the pressure distribution image comprising a pressure distribution represented by colors that is generated based on a predetermined force applied to the footwear; analyzing the pressure distribution image, the analyzing including comparing the pressure distribution image to a pressure distribution image of an authentic version of the footwear; based on the analyzing, determining whether the pressure distribution image is within an authenticity threshold of the pressure distribution image of the authentic version; and based on the pressure distribution image being within the authenticity threshold, causing presentation of an indication of authenticity of the footwear.

In example 2, the subject matter of example 1 can optionally include wherein analyzing the pressure distribution image comprises applying the pressure distribution image for the footwear to a machine learning model that is trained with training data including data derived from the pressure distribution image of the authentic version of the footwear.

In example 3, the subject matter of any of examples 1-2 can optionally include training the machine learning model using the training data derived from the pressure distribution images for authentic and counterfeit footwear.

In example 4, the subject matter of any of examples 1-3 can optionally include wherein training the machine learning model includes training on a year for each of the authentic footwear; and the analyzing is based in part on a year of the item.

In example 5, the subject matter of any of examples 1-4 can optionally include wherein the pressure distribution image comprises a pressure distribution heatmap or a pedobarographic measurement image generated based on a force applied to the footwear.

In example 6, the subject matter of any of examples 1-5 can optionally include wherein the pressure distribution image comprises a video of dynamic pressure distributions during a step performed with the footwear by a pressure measurement machine.

In example 7, the subject matter of any of examples 1-6 can optionally include wherein the request includes a brand, model, and size of the footwear to be authenticated and the method further comprises determining whether the footwear to be authenticated is a same size as the authentic version of the footwear; and based on the footwear being a different size, resizing the pressure distribution image of the footwear to correspond to a size of the authentic version of the footwear.

In example 8, the subject matter of any of examples 1-7 can optionally include wherein accessing the pressure distribution image for the footwear comprises generating the pressure distribution image for the footwear using a pressure measurement machine having an artificial foot comprising a plurality of sensors that applies the predetermined force to the footwear.

In example 9, the subject matter of any of examples 1-8 can optionally include wherein causing presentation of the indication of authenticity comprises graphically displaying an authenticity badge on a listing for the footwear.

Example 10 is a system for authenticating footwear using pressure distribution image analysis. The system comprises one or more processors and a memory storing instructions that, when executed by the one or more processors, cause the one or more processors to perform operations comprising receiving a request to authenticate footwear; accessing a pressure distribution image for the footwear, the pressure distribution image comprising a pressure distribution represented by colors that is generated based on a predetermined force applied to the footwear; analyzing the pressure distribution image, the analyzing including comparing the pressure distribution image to a pressure distribution image of an authentic version of the footwear; based on the analyzing, determining whether the pressure distribution image is within an authenticity threshold of the pressure distribution image of the authentic version; and based on the pressure distribution image being within the authenticity threshold, causing presentation of an indication of authenticity of the footwear.

In example 11, the subject matter of example 10 can optionally include wherein analyzing the pressure distribution image comprises applying the pressure distribution image for the footwear to a machine learning model that is trained with training data including data derived from the pressure distribution image of the authentic version of the footwear.

In example 12, the subject matter of any of examples 10-11 can optionally include wherein the operations further comprise training the machine learning model using the training data derived from the pressure distribution images for authentic and counterfeit footwear.

In example 13, the subject matter of any of examples 10-12 can optionally include wherein training the machine learning model includes training on a year for each of the authentic footwear; and the analyzing is based in part on a year of the item.

In example 14, the subject matter of any of examples 10-13 can optionally include wherein the pressure distribution image comprises a pressure distribution heatmap or a pedobarographic measurement image generated based on a force applied to the footwear.

In example 15, the subject matter of any of examples 10-14 can optionally include wherein the pressure distribution image comprises a video of dynamic pressure distributions during a step performed with the footwear by a pressure measurement machine.

In example 16, the subject matter of any of examples 10-15 can optionally include wherein the request includes a brand, model, and size of the footwear to be authenticated and the method further comprises determining whether the footwear to be authenticated is a same size as the authentic version of the footwear; and based on the footwear being a different size, resizing the pressure distribution image of the footwear to correspond to a size of the authentic version of the footwear.

In example 17, the subject matter of any of examples 10-16 can optionally include wherein accessing the pressure distribution image for the footwear comprises generating the pressure distribution image for the footwear using a pressure measurement machine having an artificial foot comprising a plurality of sensors that applies the predetermined force to the footwear.

In example 18, the subject matter of any of examples 10-17 can optionally include wherein causing presentation of the indication of authenticity comprises graphically displaying an authenticity badge on a listing for the footwear.

Example 19 is a computer-storage medium comprising instructions which, when executed by one or more processors of a machine, cause the machine to perform operations for authenticating footwear using pressure distribution image analysis. The operations comprise receiving a request to authenticate footwear; accessing a pressure distribution image for the footwear, the pressure distribution image comprising a pressure distribution represented by colors that is generated based on a predetermined force applied to the footwear; analyzing the pressure distribution image, the analyzing including comparing the pressure distribution image to a pressure distribution image of an authentic version of the footwear; based on the analyzing, determining whether the pressure distribution image is within an authenticity threshold of the pressure distribution image of the authentic version; and based on the pressure distribution image being within the authenticity threshold, causing presentation of an indication of authenticity of the footwear.

In example 20, the subject matter of example 19 can optionally include wherein accessing the pressure distribution image for the footwear comprises generating the pressure distribution image for the footwear using a pressure measurement machine having an artificial foot that applies a predetermined pressure to the footwear.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method comprising:
receiving a request to authenticate footwear;
accessing a pressure distribution image for the footwear, the pressure distribution image comprising a pressure distribution represented by colors that is generated based on a predetermined force applied to the footwear;
analyzing, using an image analysis system, the pressure distribution image, the analyzing including comparing the pressure distribution image to a pressure distribution image of an authentic version of the footwear;
based on the analyzing, determining whether the pressure distribution image is within an authenticity threshold of the pressure distribution image of the authentic version; and
based on the pressure distribution image being within the authenticity threshold, causing presentation of an indication of authenticity of the footwear.

2. The method of claim 1, wherein analyzing the pressure distribution image comprises applying the pressure distribution image for the footwear to a machine learning model that is trained with training data including data derived from the pressure distribution image of the authentic version of the footwear.

3. The method of claim 2, further comprising:
training the machine learning model using the training data derived from the pressure distribution images for authentic and counterfeit footwear.

4. The method of claim 3, wherein:
training the machine learning model includes training on a year for each of the authentic footwear; and
the analyzing is based in part on a year of the item.

5. The method of claim 1, wherein the pressure distribution image comprises a pressure distribution heatmap or a pedobarographic measurement image generated based on a force applied to the footwear.

6. The method of claim 1, wherein the pressure distribution image comprises a video of dynamic pressure distributions during a step performed with the footwear by a pressure measurement machine.

7. The method of claim 1, wherein the request includes a brand, model, and size of the footwear to be authenticated and the method further comprises:
determining whether the footwear to be authenticated is a same size as the authentic version of the footwear; and
based on the footwear being a different size, resizing the pressure distribution image of the footwear to correspond to a size of the authentic version of the footwear.

8. The method of claim 1, wherein accessing the pressure distribution image for the footwear comprises generating the pressure distribution image for the footwear using a pressure measurement machine having an artificial foot comprising a plurality of sensors that applies the predetermined force to the footwear.

9. The method of claim 1, wherein causing presentation of the indication of authenticity comprises graphically displaying an authenticity badge on a listing for the footwear.

10. A system comprising:
one or more processors; and
a memory storing instructions that, when executed by the one or more processors, cause the one or more processors to perform operations comprising:
receiving a request to authenticate footwear;
accessing a pressure distribution image for the footwear, the pressure distribution image comprising a pressure distribution represented by colors that is generated based on a predetermined force applied to the footwear;
analyzing the pressure distribution image, the analyzing including comparing the pressure distribution image to a pressure distribution image of an authentic version of the footwear;
based on the analyzing, determining whether the pressure distribution image is within an authenticity threshold of the pressure distribution image of the authentic version; and
based on the pressure distribution image being within the authenticity threshold, causing presentation of an indication of authenticity of the footwear.

11. The system of claim 10, wherein analyzing the pressure distribution image comprises applying the pressure distribution image for the footwear to a machine learning model that is trained with training data including data derived from the pressure distribution image of the authentic version of the footwear.

12. The system of claim 11, wherein the operations further comprise:
training the machine learning model using the training data derived from the pressure distribution images for authentic and counterfeit footwear.

13. The system of claim 12, wherein:
training the machine learning model includes training on a year for each of the authentic footwear; and
the analyzing is based in part on a year of the item.

14. The system of claim 10, wherein the pressure distribution image comprises a pressure distribution heatmap or a pedobarographic measurement image generated based on a force applied to the footwear.

15. The system of claim 10, wherein the pressure distribution image comprises a video of dynamic pressure distributions during a step performed with the footwear by a pressure measurement machine.

16. The system of claim 10, wherein the request includes a brand, model, and size of the footwear to be authenticated and the method further comprises:
determining whether the footwear to be authenticated is a same size as the authentic version of the footwear; and
based on the footwear being a different size, resizing the pressure distribution image of the footwear to correspond to a size of the authentic version of the footwear.

17. The system of claim 10, wherein accessing the pressure distribution image for the footwear comprises generating the pressure distribution image for the footwear using a pressure measurement machine having an artificial foot comprising a plurality of sensors that applies the predetermined force to the footwear.

18. The system of claim 10, wherein causing presentation of the indication of authenticity comprises graphically displaying an authenticity badge on a listing for the footwear.

19. A machine-storage medium comprising instructions which, when executed by one or more processors of a machine, cause the machine to perform operations comprising:
receiving a request to authenticate footwear;
accessing a pressure distribution image for the footwear, the pressure distribution image comprising a pressure distribution represented by colors that is generated based on a predetermined force applied to the footwear;
analyzing the pressure distribution image, the analyzing including comparing the pressure distribution image to a pressure distribution image of an authentic version of the footwear;
based on the analyzing, determining whether the pressure distribution image is within an authenticity threshold of the pressure distribution image of the authentic version; and
based on the pressure distribution image being within the authenticity threshold, causing presentation of an indication of authenticity of the footwear.

20. The machine-storage medium of claim 19, wherein accessing the pressure distribution image for the footwear comprises generating the pressure distribution image for the footwear using a pressure measurement machine having an artificial foot that applies a predetermined pressure to the footwear.
